(19) United States
(12) Patent Application Publication
(10) Pub. No.: US 2026/0221605 A1
(43) Pub. Date: Jul. 30, 2026

(54) SECONDARY CELL

(71) Applicant: Northvolt AB, Stockholm (SE)

(72) Inventors: Tetsuya MAKINO, Solna (SE); Michael SHAUGHNESSY, Västerås (SE)

(21) Appl. No.: 19/141,933

(22) PCT Filed: Dec. 20, 2023
(86) PCT No.: PCT/EP2023/087075

§ 371 Date: Jun. 20, 2025

(30) Foreign Application Priority Data
Dec. 23, 2022 (SE) 2251581-1

(51) Int. Cl. H01M 50/533; H01M 10/0587; H01M 50/107; H01M 50/152; H01M 50/536

(52) U.S. Cl. CPC H01M 50/533; H01M 10/0587; H01M 50/107; H01M 50/152; H01M 50/536

(57) ABSTRACT

There is disclosed herein a cylindrical secondary cell (1) and a method of manufacture thereof. The cell comprises a cylindrical enclosure (2) for housing an electrode roll (20), comprising a first and second enclosure end (2a, 2b) and an enclosure sidewall (2c) extending therebetween, wherein at least one enclosure end (2b) is open, a lid (10), and a current collector disc (24 ) for arranging in direct electrical contact with the electrode roll (20). The cylindrical enclosure (2) comprises a reduced radius section (2r) at the open enclosure end (2b), the current collector disc (24) comprises a first flange section (24f) that is configured to abut the reduced radius section (2r) at an outer or inner surface thereof, and the lid (10) comprises a second flange section (10f) that is configured to surround the first flange section (24f) and the reduced radius section. The lid (10) and the current collector disc (24) are configured to be attached to the cylindrical enclosure (2) by the first and second flange sections (10f, 24f) being attached to the reduced radius section (2r).

### TECHNICAL FIELD

The present disclosure generally pertains to cylindrical secondary cells and more precisely to a cylindrical secondary cell having an enclosure with an open end to which a lid is attached.

### BACKGROUND

In addressing climate change, there is an increasing demand for rechargeable batteries, e.g., to enable electrification of transportation and to supplement renewable energy. Currently, lithium-ion batteries are becoming increasingly popular. They represent a type of rechargeable battery in which lithium ions move from the negative electrode to the positive electrode during discharge and back when charging.

As the demand for rechargeable batteries increases, more and more focus is being placed on production speed and cost. To achieve an effective production of rechargeable batteries, the design of the batteries as well as their manufacturing process can be optimized.

A rechargeable battery, often referred to as a secondary battery, typically comprises one or more secondary cells electrically connected to each other.

### SUMMARY

It is in view of the above considerations and others that the embodiments of the present invention have been made. The present disclosure aims at providing highly reliable secondary cells that are efficient in manufacture. The number of components is to be reduced and the assembly thereof is to be simplified.

According to a first aspect of the present disclosure, there is provided a cylindrical secondary cell (also referred to as simply a ‘cell’), comprising a cylindrical enclosure having a first enclosure end, a second enclosure end, and an enclosure sidewall extending between the enclosure ends, wherein at least one enclosure end is open and the cylindrical enclosure comprises a reduced radius section at the open enclosure end. The cell further comprises a lid and a current collector disc, wherein the current collector disc comprises a first flange section that is configured to abut the reduced radius section at an outer or inner surface thereof, and the lid comprises a second flange section that is configured to surround the first flange section and the reduced radius section. The lid and the current collector disc are configured to be attached to the cylindrical enclosure by the first and second flange sections being welded to the reduced radius section.

By attaching the current collector disc and the lid to the cylindrical enclosure via flanges formed thereon, the ease with which the cell can be manufactured is advantageously improved. That is, the flanges provide an advantageous means for centering and aligning the current collector disc and the lid with the cylindrical enclosure and provide a readily accessible surface for welding. Hence, the seal provided by the lid, and the electrical connection provided between the current collector disc and the cylindrical enclosure may be enhanced. Moreover, the arrangement of the lid to surround the reduced radius section of the cylindrical enclosure, as well as the current collector disc, allows for an improved volumetric efficiency of the cylindrical cell, such that a larger electrode roll may be installed within the cell compared to, e.g., an example wherein the lid is crimped or seamed to attach it to the cylindrical enclosure.

According to an example, the current collector disc is configured to abut the reduced radius section at an inner surface thereof, and the lid is configured to be attached to the cylindrical enclosure by an attachment between the second flange section and the reduced radius section. In an optional refinement, the first flange section may be arranged substantially flush with the enclosure sidewall so as to provide external dimensions to the cell that are substantially overall cylindrical and to improve the ease of mounting/installing the cell.

According to another example, the current collector disc is configured to abut the reduced radius section at an outer surface thereof, and the lid is configured to be attached to the cylindrical enclosure by an attachment between the second flange section and the first flange section. In an optional refinement, the second flange section is arranged substantially flush with the first flange section.

The dimensions of the reduced radius section and the flanges may be configured so as to have a relation to each other. In an example implementation, an overlap of the reduced radius section and the second flange section is one to ten times, preferably two to five times, the material thickness of the thinner one of the reduced radius section and the second flange section. In a further example implementation, the reduced radius section has an axial extension of 0.5 to 5 percent of the axial extension of the cylindrical enclosure. The flanges may then be dimensioned in an axial direction to correspond to the height of the reduced radius section. Thus, the overall dimensions of the cell may be substantially uniformly cylindrical so as to enable the cell to be installed into a module or pack that is configured to receive cylindrical cells.

Furthermore, the relative arrangement and configuration of the flanges may be such that the flanges match each other, thereby providing an improved surface for welding. That is, in some examples, the reduced radius section and the second flange section are aligned at essentially the same angle to the enclosure sidewall, and/or the reduced radius section and the first flange section are aligned at substantially the same angle to the enclosure sidewall. The reduced radius section, the first flange section, and the second flange section may be substantially parallel to enclosure sidewall so that the outer dimensions of the cell define an overall cylindrical profile.

In some examples, the reduced radius section, the first flange section, and the second flange section are curved, e.g., having a same curved profile. Accordingly, a risk of a localized weakened part of the cylindrical enclosure (i.e., at a straight angled bend) may be advantageously reduced.

According to a further aspect of the present disclosure, there is provided a method for manufacturing a cylindrical secondary cell substantially as described above. The method comprises welding the first and second flange sections to the reduced radius section. It will be appreciated that, prior to performing such a welding, an electrode roll is arranged within the cylindrical enclosure and the current collector disc is arranged in direct electrical contact therewith.

The welding may be performed in sequence, such that only two components are welded together at a time, to thereby improve the ease with which the welding may be performed. For example, welding the first and second flange sections to the reduced radius section may comprise welding the second flange section to the first flange section before welding the first flange section to the reduced radius section, or welding the first flange section to the reduced radius section before welding the second flange section to the reduced radius section, depending on the implementation.

Alternatively, welding the first and second flange sections to the reduced radius section may comprise simultaneously welding the first flange section and the second flange section to the reduced radius section. Thus, the method may advantageously be performed as a single step, thereby increasing the speed with which the cylindrical cell can be manufactured.

Further advantages associated with the present disclosure, and additional conceivable features, will become clear from the following description of embodiments and examples.

### BRIEF DESCRIPTION OF THE DRAWINGS

The embodiments disclosed herein are illustrated by way of example, and not by way of limitation, in the figures of the accompanying drawings. Like reference numerals refer to corresponding parts throughout the drawings, in which:

FIG. 1 schematically illustrates a cylindrical secondary cell in cross-section,

FIG. 2 is an example embodiment of a relative arrangement of a cylindrical can, a current collector, and a lid, shown as an enlarged view corresponding to the encircled area of FIG. 1,

FIG. 3 discloses an alternative embodiment to the one of FIG. 2, and

FIG. 4 discloses another alternative embodiment to the one of FIG. 2.

### DETAILED DESCRIPTION

Embodiments of the present disclosure will now be described more fully hereinafter. The invention may, however, be embodied in many different forms and should not be construed as limited to the embodiments set forth herein; rather, these embodiments are provided by way of example so that this disclosure will be thorough and complete, and will fully convey the scope of the invention to those persons skilled in the art.

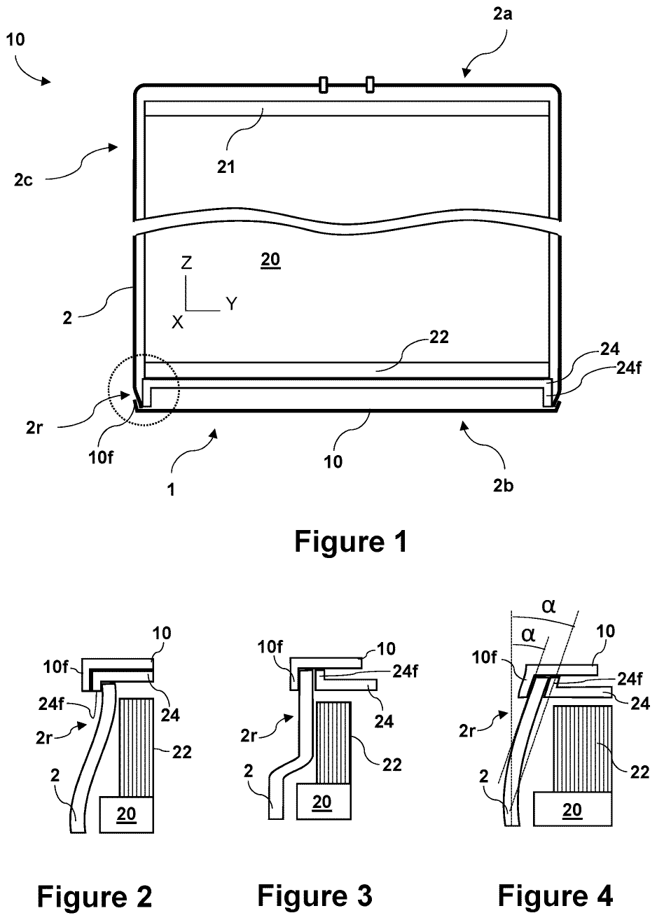

FIG. 1 shows a cylindrical secondary cell 1 (hereinafter referred to as cell) in a cross-sectional side view. In the exemplified embodiment, the cell 1 is cylindrical. The cell 1 comprises a cylindrical enclosure 2 having a first enclosure end 2a, an opposite second enclosure end 2b and an enclosure sidewall 2c that extends between the enclosure ends 2a, 2b.

In the exemplified embodiment, the first and second enclosure ends 2a, 2b are circular. The enclosure sidewall 2c is circular cylindrical. The cell 1, and thus its enclosure sidewall 2c, may be elongate and extend along a longitudinal axis (Z-axis in FIG. 1). The enclosure ends 2a, 2b may extend in planes (XY-planes in FIG. 1) that are perpendicular to the longitudinal axis. As is illustrated, the first enclosure end 2a, or first enclosure end side (top side in FIG. 1), may be formed in one piece with the enclosure sidewall 2c.

The second enclosure end 2b may be open and a separate lid 10 may, as shown, be attached to the cylindrical enclosure 2 at the open enclosure end 2b. Thus, the lid 10 may form the second enclosure end side (bottom side in FIG. 1). Alternatively, both ends sides may be formed by respective lids. In typical embodiments, as is illustrated in FIG. 1, the main portion of the enclosure sidewall 2c is essentially straight. The main portion of the enclosure sidewall 2c extends in parallel with the longitudinal axis (Z-axis in FIG. 1) of the cell 1. For example, the main portion of the enclosure sidewall 2c may be defined as at least 80 percent of the enclosure sidewall 2c extension along the longitudinal axis.

In the present embodiments, see FIGS. 1 to 4, the cylindrical enclosure 2 comprises a reduced radius section 2r at the open enclosure end 2b. More precisely, the reduced radius section 2r may be arranged axially between the below-described electrode roll 20 and the open enclosure end 2b. The reduced radius section 2r may be the ultimate portion of the enclosure sidewall 2c, at the open end 2b of the latter. The reduced radius section 2r may constitute less than the ultimate 10 percent, or less than 5 percent, of the enclosure sidewall 2c at its open end 2b.

The reduced radius section 2r may extend at an angle α to the longitudinal axis of the cell 1. In other words, the reduced radius section 2r may extend at an angle α to the enclosure sidewall 2c.

The reduced radius section 2r may be curved. A curved element or line may be considered as extending at an angle. It may therefore be appropriate to define the reduced radius section 2r as essentially extending at an angle α to the longitudinal axis of the cell 1.

During assembly, the lid 10 may be held or clamped towards the outer surface of the reduced radius section 2r of the cylindrical enclosure 2 and simultaneously be secured thereto by welding, such as laser welding, ultrasonic welding, or the like.

In the embodiment of FIG. 1, the reduced radius section 2r at the open enclosure end 2b is formed by the enclosure sidewall 2c being bent inwards relatively abruptly. In this embodiment, the main portion of the enclosure sidewall 2c has a straight cylindrical shape whereas the reduced radius section 2r has a conical shape. The reduced radius section 2r can thus be said to have a straight extension, in other words be straight. The transition between the straight cylindrical shape and the conical shape is abrupt in the embodiment of FIG. 1.

In order to securely attach the lid 10 to the reduced radius section 2r, the lid 10 comprises a flange 10f that extends at an angle to the longitudinal axis of the cell 1. The flange 10f may extend at essentially the same angle α to the longitudinal axis of the cell 1 as does the reduced radius section 2r. Also, the radius of the lid 10 may be tailored to the radius of the cylindrical enclosure 2, taking the angle and optionally the extension (length) of the reduced radius section 2r into account. In other words, the flange 10f or a section thereof is configured to surround and abut against the reduced radius section 2r. In this way, a relatively large contact surface between the reduced radius section 2r and the flange 10f may be obtained, which ensures a highly reliable attachment between cylindrical enclosure 2 and the lid 10 by a subsequently arranged weld.

The angle may for example be from a few, such as 5, degrees to 60 degrees. In the embodiment of FIG. 1, the angle is in the range of 30 to 50 degrees.

The cell 1 shown in FIG. 1 further comprises a current collector disc 24, which may be substantially circular shaped or may have some other shape depending on the implementation. Around at least a part of the periphery of the current collector disc 24 is a flange 24f extending axially. In the illustrated example, the flange 24f is straight extends at 90 degrees to the main section of the current collector disc 24. However, it will be appreciated that, in some examples, the flange 24f may be curved or have a different shape and may extend at a different angle to the main section of the current collector disc 24. In the illustrated example, the flange 24f abuts an inner surface of the reduced radius section 2r of the cylindrical enclosure. The current collector disc 24 may then be attached to the cylindrical enclosure 2 via the flange 24f, e.g., before the lid 10 is introduced and attached to the cylindrical enclosure 2.

FIG. 2 discloses an embodiment similar to the one of FIG. 1, but where the reduced radius section 2r and the flange section 10f are curved in an S-shape, and where the flange 24f of the current collector 24 abuts an outer surface of the reduced radius section 24f. In this case, the reduced radius section 2r essentially extends at an angle to the longitudinal axis of the cell 1 and the flange (or a section thereof) 10f of the lid 10 is configured (sized and shaped) to surround and abut against the current collector disc 24.

By arranging the current collector disc 24 around an outside of the cylindrical enclosure 2 in this way, more space is allowed within the internal volume of the cell 1, and thus the electrode roll 20 may be larger in size, thereby improving the energy density of the cell 1.

In order to manufacture such an arrangement, the current collector disc 24 may first be welded to the cylindrical enclosure 2 via the flange 24f, and then the lid may be welded to the current collector disc 24 via the flange 10f. Alternatively, the lid 10 and the current collector disc 24 may be welded to each other before both welded components are arranged on and welded to the cylindrical enclosure 2.

In an alternative implementation to that illustrated in FIG. 2, the flange 10f may extend below and beyond the flange 24f of the current collector disc 10f and may abut and be welded to the cylindrical enclosure at a location separate to that at which the current collector disc 24 is welded to the cylindrical enclosure 24.

FIG. 3 discloses an embodiment where the reduced radius section 2r is straight, the flange 10f, and the flange 24f are straight. In this embodiment, the flange 24f of the current collector disc 24 abuts an inner surface of the reduced radius section 2r.

Furthermore, in this case, the reduced radius section 2r extends in parallel with the longitudinal axis of the cell 1. As is illustrated in FIG. 3, the reduced radius section 2r is again positioned in an S-shaped structure. However, unlike FIG. 2 where the ultimate portion of the enclosure sidewall 2c is S-shaped, only a transitional section forms an S-shape.

In this example, the flange section 10f of the lid 10 is configured to surround and abut against an outer surface of the reduced radius section 2r, which in this embodiment is aligned in parallel with the longitudinal axis of the cell 1. In other words, the flange 10f is straight and forms a right angle to the plane (XY-plane) within which the lid 10 extends, i.e. the plane of the open end 2b.

The flange 24f of the current collector disc 24 is arranged to abut an inner surface of the reduced radius section 2r, and is configured to extend parallel with the longitudinal axis of the cell 1 and thus parallel with the end of the reduced radius section 2r and the flange 10f of the lid 10. According to such an example, an improved trade-off between ease of manufacture and volumetric efficiency may be obtained.

FIG. 4 discloses an embodiment that is similar to the one of FIG. 3, but where the reduced radius section 2r, and the flanges 10f and 24f are curved at a same angle α to the longitudinal axis of the cell 1.

The present embodiments typically involve an overlap of the reduced radius section 2r and the flange 10f (or a section thereof) that is one to ten times, preferable two to five times, the material thickness of the thinner one of the reduced radius section 2r and the flange section 10f.

The flanges 10f and 24f are attached, or secured, to the reduced radius section 2r by welding. Typically, there is no other attachment between the lid 10 and the cylindrical enclosure 2. Thus, the lid 10 and the current collector disc 24 may be attached to the cylindrical enclosure 2 solely by the attachment between the flange 10f of the lid 10, the flange 24f of the current collector disc 24, and the reduced radius section 2r of the cylindrical enclosure 2. Thus, no additional separate component, or manufacturing steps, are required for attaching the lid 10 or the current collector disc 24 to the cylindrical enclosure 2. The direct attachment of the lid 10 and the current collector disc 24 to the cylindrical enclosure 2 may increase the usable volume inside the cell 1.

According to some examples, the cylindrical enclosure 2 provides an outer attachment surface to which an inner attachment surface of the lid 10 is attached, and further provides an inner attachment surface to which an outer attachment surface of the current collector disc 24 is attached. These attachment interfaces be the only attachment interface between the lid 10, the current collector disc 24, and the cylindrical enclosure 2.

As is illustrated in FIG. 1, the cell 1 may be configured such that the lid 10 does not protrude radially beyond the cylindrical enclosure 2. This may be beneficial as a great number of cells 1 are typically arranged next to one another or in a holder structure in a secondary battery. In this connection, a protruding lid may impede an assembly process or a tight arrangement of cells. The cell 1 may be configured such that the flange 10f is essentially flush with the enclosure sidewall 2s as is illustrated in FIGS. 1 to 4. This design may be beneficial for the usable volume inside the cell 1.

FIG. 1 illustrates a cell 1 of a type that has both a positive terminal and a negative terminal at one and the same end 2a (the top end in FIG. 1) of the cylindrical secondary cell 1. The first enclosure end 2a comprises a central terminal through-hole for the positive terminal. The negative terminal is electrically connected to the cylindrical enclosure 2. More precisely, the negative terminal is formed by the top surface of the cylindrical enclosure 2 that surrounds the terminal through-hole. Thus, the entire cylindrical enclosure 2 (apart from the positive terminal at the top end) may be the negative terminal.

A cell 1 having both terminals at one end may bring advantages as regards electrically connecting the cell to a load. Conductors electrically connecting the terminals to the load may be positioned on the same end, the terminal end (top side in FIG. 1), of the cell. The opposite end, which may be referred to as the electrolyte-filling end (bottom end in FIG. 1), of the cell 1 may be dedicated to electrolyte filling and venting. An overpressure may be generated within the cell during operation, in particular upon malfunction of the cell or of the load connected to the cell. Such malfunction may require a release of gas and/or other ejecta out of the cell, and it may be advantageous to direct the released gas and/or other ejecta away from the conductors, i.e.

at the end opposite to the terminal end.

A number of cells 1 may be positioned at a low position in an electric vehicle. The cells 1 may be arranged with the terminal ends directed upwards and the electrolyte-filling ends (bottom end 2b in FIG. 1) directed downwards. Upon malfunction, for example resulting from a faulty electric vehicle charger or a faulty cell 1, a release of gas and/or other ejecta from the electrolyte-filling end(s) will be advantageously directed downwards towards the ground beneath the vehicle. In other applications than vehicles, the electrolyte-filling ends may be directed towards a desired location such that any gas and/or other ejecta will not cause damages or injuries.

As is illustrated in FIG. 1, the cell 1 may comprise an electrode roll 20. The electrode roll 20 comprises a first and a second conductive sheet 21, 22 and separating means (not shown). The separating means may also be termed separator. The conductive sheets 21, 22 and the separating means are rolled to form a circular cylindrical roll. The conductive sheets 21, 22 are coated with electrode coatings and on assembly of the cell 1, the cylindrical enclosure 2 is filled with an electrolyte. The coatings on the conductive sheets 21, 22 act as cathode and anode, respectively. The cathode, anode and electrolyte provide electrochemical energy storage. This principle is known per se, and the electrode roll 20 is commonly referred to as a jellyroll.

The conductive sheets 21, 22 of the electrode roll 20 may be axially offset in relation to one another, and each conductive sheet may comprise an end section that is not coated with electrode coating. Via the non-coated end sections, the respective ends of the electrode roll may be efficiently electrically connected to a respective assigned terminal of the cell 1. This design is known per se and commonly referred to as a tabless cell. As is illustrated in FIG. 1, one 22 of the conductive sheets may be in electrical contact, more precisely in direct electrical contact, with the current collector disc 24, which may be shaped to extend towards the conductive sheet 22, e.g., with a plurality of recessed portions. Direct electrical contact may be referred to as physical contact.

The lid 10 may comprise a filling opening for electrolyte filling. The filling opening may be arranged in a recessed filling portion. The current collector disc 24 may further comprise electrolyte openings to allow for ease of flow of electrolyte throughout the cell 1. The filling opening may be aligned with one or more of the electrolyte openings on the current collector disc 24 and may be sealed by a sealing element such as for example a rivet, such as a blind rivet.

The enclosure sidewall 2c, or at least the reduced radius section 2r, may have a constant material thickness. In some applications, the ultimate portion of the reduced radius section 2r may be of a thinner material thickness than the remaining reduced radius section 2r and enclosure sidewall 2c.

In FIGS. 1 to 4, the material thickness of the cell 1 and the lid 10 have been exaggerated to elucidate the features of the present disclosure. For the same reason, the figures illustrate a certain gap between the cylindrical enclosure 2, the current collector disc 24, and the lid 10. It is to be understood that in actual implementations the lid 10 and current collector will be brought in direct contact with the cylindrical enclosure 2 and/or each other before attachment e.g. by welding.

While the present disclosure is susceptible to various modifications and alternative forms, specific examples are shown and described in relation to the drawings, with a view to clearly explaining the various advantageous aspects of the present disclosure. It should be understood, however, that the detailed description herein and the drawings attached hereto are not intended to limit the disclosure to the particular form disclosed. Rather, the intention is to cover all modifications, equivalents, and alternatives falling within the scope of the following claims, including the possible combination of various elements of these specific examples.

1. A cylindrical secondary cell (1), comprising:
a cylindrical enclosure (2) for housing an electrode roll (20), comprising a first enclosure end (2a), a second enclosure end (2b) and an enclosure sidewall (2c) extending between the enclosure ends (2a, 2b), wherein at least one enclosure end (2b) is open,
a lid (10), and
a current collector disc (24) for arranging in direct electrical contact with the electrode roll (20),
wherein:
the cylindrical enclosure (2) comprises a reduced radius section (2r) at the open enclosure end (2b),
the current collector disc (24) comprises a first flange section (24f) that is configured to abut the reduced radius section (2r) at an outer or inner surface thereof, an
the lid (10) comprises a second flange section (10f) that is configured to surround the first flange section (24f) and the reduced radius section, and the lid (10) and the current collector disc (24) are configured to be attached to the cylindrical enclosure (2) by the first and second flange sections (10f, 24f) being attached to the reduced radius section (2r).

2. The cylindrical secondary cell (1) of claim 1, wherein the current collector disc is configured to abut the reduced radius section at an inner surface thereof, and the lid (10) is configured to be attached to the cylindrical enclosure (2) by an attachment between the second flange section (10f) and the reduced radius section (2r).

3. The cylindrical secondary cell (1) of claim 2, configured such that the flange section (10f) is arranged substantially flush with the enclosure sidewall (2c).

4. The cylindrical secondary cell (1) of claim 1, wherein the current collector disc is configured to abut the reduced radius section at an outer surface thereof, and the lid (10) is configured to be attached to the cylindrical enclosure (2) by an attachment between the second flange section (10f) and the first flange section (24f).

5. The cylindrical secondary cell (1) of claim 4, configured such that the second flange section (10f) is arranged substantially flush with the first flange section (24f).

6. The cylindrical secondary cell (1) of claim 1, wherein an overlap of the reduced radius section (2r) and the second flange section (10f) is one to ten times, the material thickness of the thinner one of the reduced radius section (2r) and the second flange section (10f).

7. The cylindrical secondary cell (1) of claim 1, wherein the reduced radius section (2r) has an axial extension of 0.5 to 5 percent of the axial extension of the cylindrical enclosure (2).

8. The cylindrical secondary cell (1) of claim 1, wherein the reduced radius section (2r) and the second flange section (10f) are aligned at essentially the same angle (a) to the enclosure sidewall (2c).

9. The cylindrical secondary cell (1) of claim 1, wherein the reduced radius section (2r) and the first flange section (xx) are aligned at substantially the same angle (a) to the enclosure sidewall (2c).

10. The cylindrical secondary cell (1) of claim 1, wherein the reduced radius section (2r), the first flange section, and the second flange section (10f) are curved.

11. The cylindrical secondary cell (1) of claim 1, wherein the reduced radius section (2r), the first flange section, and the second flange section (10f) are substantially parallel to enclosure sidewall (2c).

12. A method for manufacturing the cylindrical secondary cell according to claim 1, the method comprising welding the first and second flange sections (1 Of, 24f) to the reduced radius section (2r).

13. The method of claim 12, wherein welding the first and second flange sections (10f, 24f) to the reduced radius section (2r) comprises welding the second flange section (10f) to the first flange section (24f) before welding the first flange section to the reduced radius section (2r).

14. The method of claim 12, wherein welding the first and second flange sections (10f, 24f) to the reduced radius section (2r) comprises welding the first flange section (10f) to the reduced radius section (2r) before welding the second flange section to the reduced radius section.

15. The method of claim 12, wherein welding the first and second flange sections (10f, 24f) to the reduced radius section (2r) comprises simultaneously welding the first flange section and the second flange section (10f) to the reduced radius section (2r).

16. The cylindrical secondary cell (1) of claim 1, wherein an overlap of the reduced radius section (2r) and the second flange section (10f) is two to five times the material thickness of the thinner one of the reduced radius section (2r) and the second flange section (10f).
